(19) United States
(12) Patent Application Publication
(10) Pub. No.: US 2009/0075170 A1
(43) Pub. Date: Mar. 19, 2009

(54) Continuous-feed electrochemical cell

(75) Inventor: John F. Cooper, Oakland, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(73) Assignee: The Regents of the University of California

(21) Appl. No.: 11/901,091

(22) Filed: Sep. 13, 2007

(51) Int. Cl. H01M 6/02

(52) U.S. Cl. 429/188; 429/122

(57) ABSTRACT

A continuous-feed electrochemical cell with a cell body having a cell cavity defined by at least two cavity walls. One of the cavity walls is a cavity wall that is inclined to vertical. A series of barriers are connected to the cavity wall that is inclined to vertical. Electrochemically active particles are contained within the cell cavity. An electrolyte solution is also contained within the cell cavity. A cathode current collector is operatively connected to the cavity wall that is inclined to vertical, to the electrochemically active particles, and to the electrolyte solution. An anode current collector is operatively connected to the cavity wall that is inclined to vertical, to the electrochemically active particles, and to the electrolyte solution.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to electrochemical cells and more particularly to a continuous-feed electrochemical cell.

2. State of Technology

U.S. Pat. No. 4,147,839 for electrochemical cell with stirred slurry, issued to Frank Solomon et al Apr. 3, 1979 provides the following state of technology information: “In a battery of electrochemical unit cells in which an active metal in powder form is an electrode, high rate reaction at high efficiency is achieved by slurrying the powdered metal in the cell electrolyte. The slurrying is carried out entirely within each cell so that no transfer of electrolyte to and from the cell during discharge is necessary. Such batteries are suitable for powering vehicles. A battery of such cells can be emptied and then refuelled either by pressure or by vacuum; in one embodiment the active metal can be regenerated in each of the cells from the discharge products formed therein.”

U.S. Pat. No. 4,147,839 for electrodes for metal/air batteries and fuel cells and metal/air batteries incorporating the same issued to Avner Brokman et al Feb. 9, 1993 provides the following state of technology information: “ . . . an air cathode in combination with an oxygen-rich electrolyte-immiscible organic fluid for supplying oxygen thereto, as well as providing metal/air batteries and hydrogen-oxygen fuel cells incorporating the same.”

U.S. Pat. No. 5,434,020 for a continuous-feed electrochemical cell with nonpacking particulate electrode, issued to John F. Cooper Jul. 18, 1995 provides the following state of technology information: “An electrochemical cell providing full consumption of electrochemically active particles in a nonpacking, electrolyte-permeable bed has a tapered cell cavity bounded by two nonparallel surfaces separated by a distance that promotes bridging of particles across the cavity. The gap/particle size ratio is maintained as the particles are consumed, decrease in size, and travel from the point of entry to the narrower end of the cell. A cell of this configuration supports a bed of low packing density maintained in a dynamic steady state by alternate formation and collapse of particle bridges across the gap and associated voids over the entire active area of the cell. The cell design can be applied to refuelable zinc/air cells and zinc/ferrocyanide storage batteries.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

If the containment surface of a continuous-feed electrochemical cell is inclined at an angle of 5° to 20° to vertical, such that the angle of inclination is greater than the angle of repose, the electrochemically active particles will tend to slide over the surface during the process of feed, and small particles will tend to accumulate at the base of the cell. This will tend to clog the cell at the bottom, where liquid flow is reduced by viscous drag.

The present invention provides a continuous-feed electrochemical cell that counters this effect. A series of barriers are attached to the inclined containment surface. The barriers may be electrically conductive or non-electrically conductive. The barriers are perpendicular to the direction of slide and will slow movement of the particles but will not interrupt the fall of particles. This divides the continuous-feed electrochemical cell into two regions: a region close to the inclined containment surface in which particle movement is normal to the inclined containment surface, and a region farther from the inclined containment surface in which particle movement is predominantly parallel to the inclined containment surface. The barriers do not completely span the bed and increase friction of particle movement.

The present invention provides a continuous-feed electrochemical cell with a cell body with a cell cavity defined by at least two cavity walls. One of the cavity walls is a cavity wall that is inclined to vertical. The cavity wall that is inclined to vertical is inclined to vertical at an angle of 5° to 20° to vertical. A series of barriers are connected to the cavity wall that is inclined to vertical. Electrochemically active particles are contained within the cell cavity. An electrolyte solution is also contained within the cell cavity. A cathode current collector is operatively connected to the cavity wall that is inclined to vertical, to the electrochemically active particles, and to the electrolyte solution. An anode current collector is operatively connected to the cavity wall that is inclined to vertical, to the electrochemically active particles, and to the electrolyte solution. An electronically insulating separator is located between the anode current collector and the cathode current collector. In one embodiment a screen extends along the anode current collector and the barriers extend perpendicular to the screen.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates one embodiment of a continuous-feed electrochemical cell constructed in accordance with the present invention.

FIG. 2 is an illustration of an embodiment of an anode and screen of a continuous-feed electrochemical cell constructed in accordance with the present invention.

FIG. 3 is an illustration of another embodiment of an anode and screen of a continuous-feed electrochemical cell constructed in accordance with the present invention.

FIG. 4 illustrates another embodiment of a continuous-feed electrochemical cell constructed in accordance with the present invention.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

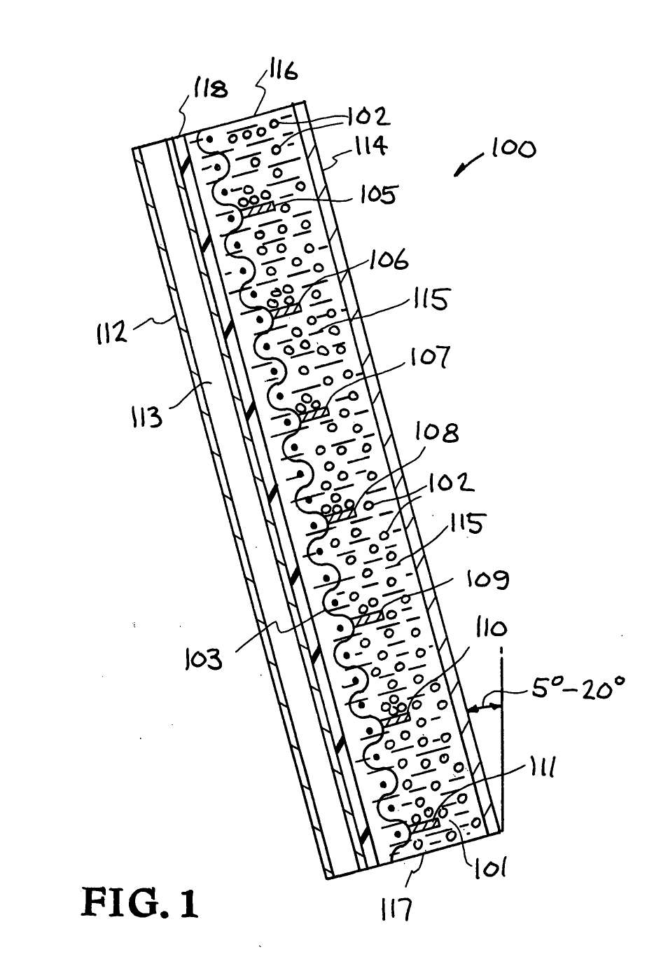

Referring now to the drawings and in particular to FIG. 1, one embodiment of a continuous-feed electrochemical cell constructed in accordance with the present invention is illustrated. This embodiment of a continuous-feed electrochemical cell is designated generally by the reference numeral 100. The continuous-feed electrochemical cell 100 provides consumption of electrochemically active particles in an electrolyte-permeable bed located in a cell cavity. The particles are consumed, as they travel from the point of entry to the end of the cell. The continuous-feed electrochemical cell 100 produces electrical energy and has many uses. For example, the continuous-feed electrochemical cell 100 can be used in refuelable zinc/air cells and zinc/ferrocyanide storage batteries.

The continuous-feed electrochemical is an electrochemical cell 100 with a cell cavity that provides a particle bed 101. Electrochemically active particles 102 are contained in the particle bed 101. The particle bed 101 is located between an anode current collector 103 with screen 104 and cell wall 114. The particle bed 101 is permeated with an electrolyte solution 115. A porous, electronically insulating separator 118 is located between a gaseous diffusion cathode 112 and the anode current collector 103 with screen 104. The gaseous diffusion cathode 112 is shown as an air cathode 112. An air space 113 is shown in air cathode 112. A plurality of projecting barriers 105, 106, 107, 108, 109, 110, and 111 extend from the screen 104 and the anode current collector 103. The projecting barriers 105, 106, 107, 108, 109, 110, and 111 can be electrically conductive barriers such as metal barriers or the projecting barriers 105, 106, 107, 108, 109, 110, and 111 can be non-electrically conductive barriers such as insulators. The projecting barriers 105, 106, 107, 108, 109, 110, and 111 can be part of the anode current collector 1-3.

The electrochemically active particles 102 are contained within the cell cavity 101. The electrolyte solution 115 is also contained within the cell cavity 101. The cathode current collector 112 is operatively connected to the electronically insulating separator 118, the anode 103, the screen 104, and wall 114. The cathode current collector 112, the electronically insulating separator 118, the anode 103, the screen 104, and wall 114 are inclined to vertical. In the embodiment shown in FIG. 1 they are inclined to vertical at an angle of 5° to 20° to vertical. The electrochemically active particles 102 flow along the electronically insulating separator 118 and the anode 103 with screen 104. The barriers 105, 106, 107, 108, 109, 110, and 111 are positioned perpendicular to the electronically insulating separator 118 and the anode 103 with screen 104. The screen 104 extends along the anode current collector 103 with barriers 105, 106, 107, 108, 109, 110, and 111 extending perpendicular to the screen 104.

The cell cavity that forms the particle bed 102 has an end 116 for the entrance of the electrochemically active particles 102 and an end 117 wherein the any unused electrochemically active particles 102 and fluid can exit. The electrolyte solution 115 can be introduced through end 116 or end 117. The electrochemically active particles 102 enter end 116 of the cell 100 and pass through the cell 100 in one direction. The ratio of the distance between the walls of cell 100 at any point along the walls and the average diameter of the electrochemically active particles 102 at that point is in the range of about 1 to 7. The distance between the cavity walls can result in bridging of electrochemically active particles 102 across the cell cavity and formation of voids between the electrochemically active particles 102.

If the inclined surface of the continuous-feed electrochemical cell 100 is inclined at an angle of 5° to 20° to vertical, such that the angle of inclination is greater than the angle of repose, the active particles 102 will tend to slide over the surface (or the attached screen 104) during the process of feed, and small particles will tend to accumulate at the end 117 of the cell 100. This will tend to clog the cell 100 at the bottom, where liquid flow is reduced by viscous drag. The barriers 105, 106, 107, 108, 109, 110, and 111 slow movement of the active particles 102 adjacent to the screen 104 but will not interrupt the fall of active particles 102. The barriers 105, 106, 107, 108, 109, 110, and 111 may be electrically conductive or inert. The barriers 105, 106, 107, 108, 109, 110, and 111 do not completely span the bed. The barriers 105, 106, 107, 108, 109, 110, and 111 increase friction for active particle 102 movement.

In operation of the continuous-feed electrochemical cell 100, the electrochemically active particles 102 enter the cell 100 and pass through the cell cavity in one direction. The particle bed 101 is permeated with the electrolyte solution 115, which typically enters the end 117 of the cell 101 and exits the end 116. The reverse flow is also possible. Air flows through air space 113 in the air cathode 112. Electrical power is produced by the voltage potential difference between the cathode 112 and the anode 103. Additional details of a continuous-feed electrochemical cell are described in U.S. Pat. No. 5,434,020 for a continuous-feed electrochemical cell with nonpacking particulate electrode, issued to John F. Cooper Jul. 18, 1995. U.S. Pat. No. 5,434,020 for a continuous-feed electrochemical cell with nonpacking particulate electrode, issued to John F. Cooper Jul. 18, 1995 is incorporated herein by this reference.

If the inclined surface of the continuous-feed electrochemical cell 100 is inclined at an angle of 5° to 20° to vertical, such that the angle of inclination is greater than the angle of repose, the active particles 102 will tend to slide over the surface of the electronically insulating separator 118, the anode 103, and/or the attached screen 104 during the process of feed. Small particles will tend to accumulate toward the end 117 of the cell 100. This will tend to clog the cell 100 at the bottom, where liquid flow is reduced by viscous drag. The distance between the cavity walls promotes bridging of electrochemically active particles 102 across the cell cavity and formation of voids between the electrochemically active particles 102. The ratio of the distance between the cavity walls at any point along the cavity walls and the average diameter of the electrochemically active particles 102 at that point is in the range of about 1 to 7.

The barriers 105, 106, 107, 108, 109, 110, and 111 slow movement of the active particles 102 but will not interrupt the fall of particles 102. The flow of the electrochemically active particles 102 as they enter the cell 100 is parallel to the cell walls, the cathode 112, and the anode 103. When the flow of the electrochemically active particles 102 reaches the barriers 105, 106, 107, 108, 109, 110, and 111, a portion of the flow adjacent the electronically insulating separator 118 and the anode 103 with screen 104 becomes normal to the electronically insulating separator 118 and the anode 103 with screen 104. The barriers 105, 106, 107, 108, 109, 110, and 111 increase friction for active particle 102 movement.

In one embodiment the continuous-feed electrochemical cell 100 is a zinc/ferricyanide cell. The cathode current collector 112 is a porous, inert electrode supporting ferricyanide ion reduction. The electrolyte solution 115 is an electrolyte solution comprising ferrocyanide and ferricyanide.

In another embodiment of the continuous-feed electrochemical cell 100 the anode current collector 103 is replaced by an electrically insulating screen (screen 103) and current flows through the zinc particle bed (particle bed 101) to the cell wall 114 which is a conductive metal or graphite. The particle bed 101 is permeated with the electrolyte solution 115. Electrical power is produce by the voltage potential difference between the cathode 112 and the cell wall 114 which is a conductive metal or graphite.

In yet another embodiment of the continuous-feed electrochemical cell 100 the cell wall 114 which is a conductive metal or graphite. Current flows through the zinc particle bed (particle bed 101) to the cell wall 114.

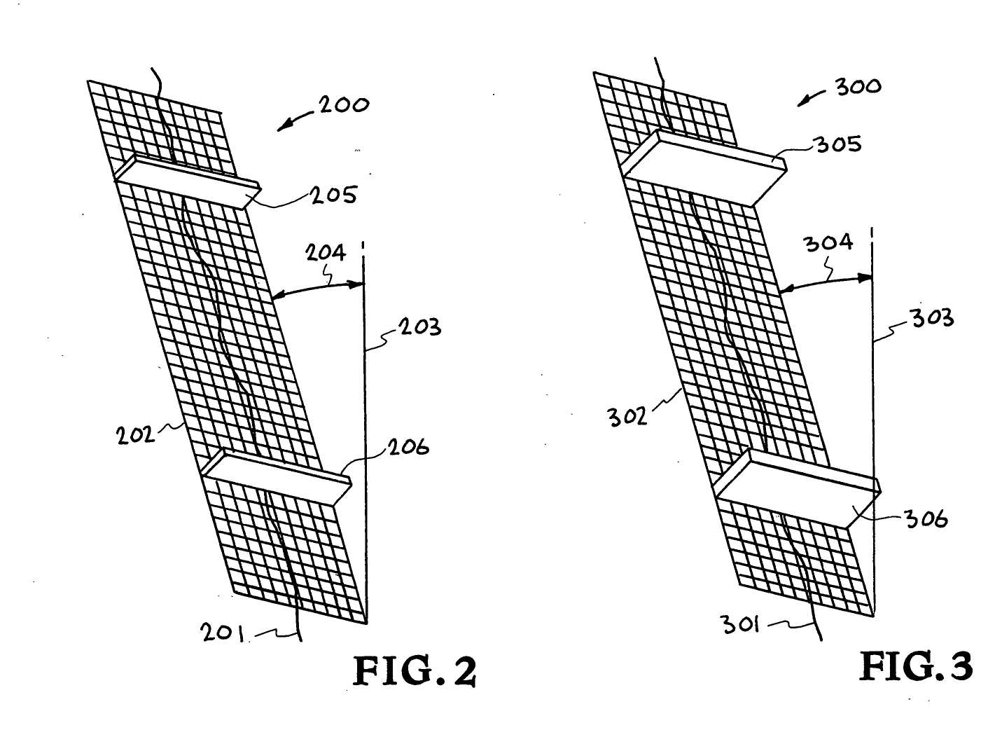

Referring now to FIG. 2, an illustration of an embodiment of an anode and screen of a continuous-feed electrochemical cell constructed in accordance with the present invention is shown. The embodiment of an anode and screen is designated generally by the reference numeral 200. The continuous-feed electrochemical cell utilizes electrochemically active particles in an electrolyte-permeable bed to produce electrical energy. The particle bed is located between an anode current collector with screen and cell wall. The particle bed is permeated with an electrolyte solution. A porous, electronically insulating separator is located between a cathode and the anode current collector with screen.

The particle bed 101 is permeated with the electrolyte solution 115. Electrical power is produce by (A) the voltage potential difference between the cathode 112 and the anode current collector 103 and (B) the voltage potential difference between the cathode 112 and the cell wall 114 which is a conductive metal or graphite.

As shown in FIG. 2 the anode 201 and screen 202 are inclined to vertical 203. In the embodiment shown in FIG. 2 the anode 201 and screen 202 are inclined to vertical at an angle 204 of 5° to 20° to vertical 203. The electrochemically active particles flow along the anode 201 and screen 202. Barriers 205 and 206 are positioned perpendicular to the anode 201 and screen 202.

The inclined anode 201 and screen 202 and the angle of inclination are greater than the angle of repose. The active particles tend to slide over the surface of anode 201 and screen 202 and small particles tend to accumulate at the end of the cell. This will tend to clog the cell at the bottom where liquid flow is reduced by viscous drag. The barriers 205 and 206 slow movement of the active particles adjacent to the screen 202 but will not interrupt the fall of active particles. The barriers 205 and 206 increase friction for active particle movement.

The flow of the electrochemically active particles as they enter the cell is parallel to the cell walls, the anode 201, and screen 202. When the flow of the electrochemically active particles reaches the barriers 205 and 206 a portion of the flow adjacent the screen 202 becomes normal to the screen 202. The barriers 205 and 206 increase friction for active particle 202 movement.

Referring now to FIG. 3, an illustration of another embodiment of an anode and screen of a continuous-feed electrochemical cell constructed in accordance with the present invention is shown. The embodiment of an anode and screen is designated generally by the reference numeral 300. The continuous-feed electrochemical cell utilizes electrochemically active particles in an electrolyte-permeable bed to produce electrical energy. The particle bed is located between an anode current collector with screen and cell wall. The particle bed is permeated with an electrolyte solution. A porous, electronically insulating separator is located between a cathode and the anode current collector with screen.

As shown in FIG. 3 the anode 301 and screen 302 are inclined to vertical 303. In the embodiment shown in FIG. 3 the anode 301 and screen 302 are inclined to vertical at an angle 304 of 5° to 20° to vertical 303. The electrochemically active particles flow along the anode 301 and screen 302. Barriers 305 and 306 extend perpendicular to the anode 301.

The inclined anode 301 angle of inclination is greater than the angle of repose. The active particles tend to slide over the surface of anode 301 and small particles tend to accumulate at the end of the cell. This will tend to clog the cell at the bottom where liquid flow is reduced by viscous drag. The barriers 305 and 306 slow movement of the active particles adjacent to the screen 302 but will not interrupt the fall of active particles. The barriers 305 and 306 increase friction for active particle movement.

The flow of the electrochemically active particles as they enter the cell is parallel to the cell walls, the anode 301, and screen 302. When the flow of the electrochemically active particles reaches the barriers 305 and 306 a portion of the flow adjacent the screen 302 becomes normal to the screen 302. The barriers 305 and 306 increase friction for active particle 302 movement.

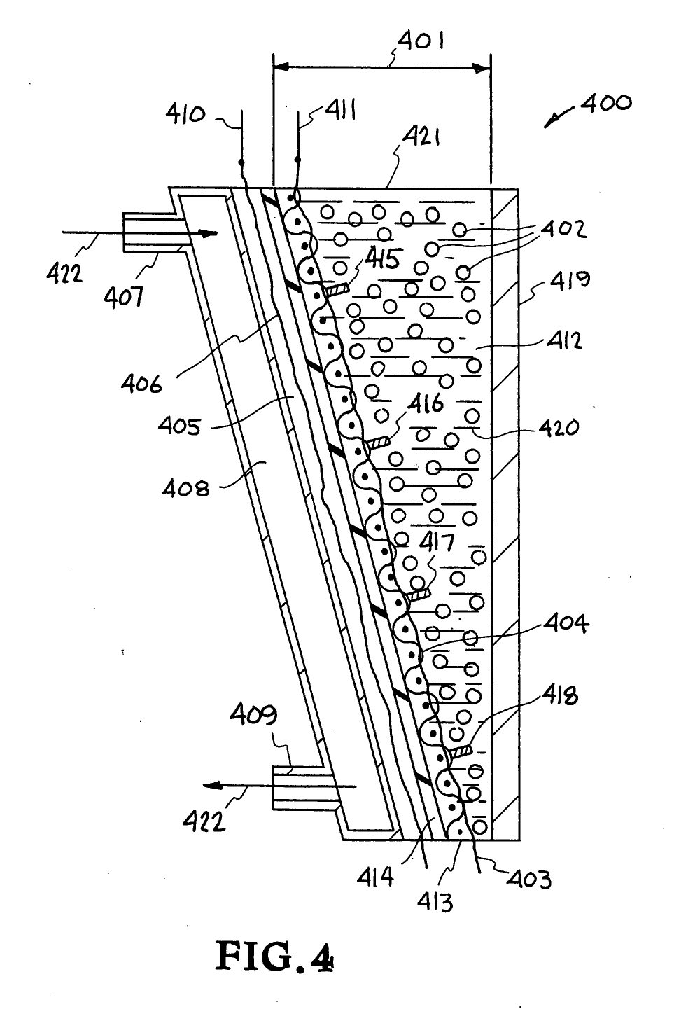

Referring now to the drawings and in particular to FIG. 4, one embodiment of a continuous-feed electrochemical cell constructed in accordance with the present invention is illustrated. This embodiment of a continuous-feed electrochemical cell is designated generally by the reference numeral 400. The continuous-feed electrochemical cell 400 provides full consumption of electrochemically active particles in a nonpacking, electrolyte-permeable bed located in a tapered cell cavity bounded by two nonparallel surfaces. The particles are consumed, as they travel from the point of entry to the narrower end of the cell. The continuous-feed electrochemical cell 400 produces electrical energy and has many uses. For example, the continuous-feed electrochemical cell 400 can be used in refuelable zinc/air cells and zinc/ferrocyanide storage batteries.

The continuous-feed electrochemical is a tapered electrochemical cell 400 with a varying gap (or cell width) dimension 401. Electrochemically active particles 402 are contained in a particle bed 412 which is located between an anode current collector 403 with screen 404 and the cell wall 419. The particle bed 412 is permeated with an electrolyte solution 420. A porous, electronically insulating separator 414 is located between a gaseous diffusion cathode 405 with an internal current collector 406 and the anode current collector 403 with screen 404. The gaseous diffusion cathode 405 is shown as an air cathode 405. A series of barriers 415, 416, 417, and 418 are attached to the screen 404 with the anode current collector 403.

The continuous-feed electrochemical cell 400 has a cell body with a tapered cell cavity that forms the particle bed 412. The tapered cell cavity is defined by cavity wall 419 and the porous, electronically insulating separator 414. One of the nonparallel cavity walls is a nonparallel cavity wall that is inclined to vertical. The barriers 415, 416, 417, and 418 are connected to the nonparallel cavity wall that is inclined to vertical.

Electrochemically active particles 402 are contained within the tapered cell cavity. An electrolyte solution 420 is contained within the tapered cell cavity. A cathode current collector 405 is operatively connected to the nonparallel cavity wall that is inclined to vertical, to the electrochemically active particles, and to the electrolyte solution. An anode current collector 403 is operatively connected to the nonparallel cavity wall that is inclined to vertical, to the electrochemically active particles, and to the electrolyte solution. The nonparallel cavity wall that is inclined to vertical at an angle of 5° to 20° to vertical. The electrochemically active particles 402 flow along the nonparallel cavity wall that is inclined to vertical is inclined to vertical at an angle of 5° to 20° to vertical. The barriers 415, 416, 417, and 418 are positioned perpendicular to the nonparallel cavity wall that is inclined to vertical. The screen 404 extends along the anode current collector 403 with barriers 415, 416, 417, and 418 extending perpendicular to the screen 404.

The tapered cell cavity that forms the particle bed 412 has an open end 421 and an open end 413. The electrochemically active particles 402 enter the tapered cell cavity and pass through the tapered cell cavity in one direction. The distance 401 between the nonparallel cavity walls promotes bridging of electrochemically active particles 402 across the tapered cell cavity and formation of voids between the electrochemically active particles 402. The ratio of the distance between the nonparallel cavity walls at any point along the nonparallel cavity walls and the average diameter of the electrochemically active particles 402 at that point is in the range of about 1 to 7.

In operation of the continuous-feed electrochemical cell 400, air 422 flows through an intake port 407, through an air flow chamber 408 situated next to the air cathode 405, and out of an air exit port 409. A positive current lead 410 and a negative current lead 411 are connected to the cathode current collector 406 and anode current collector 403, respectively. The particle bed 412 is permeated with an electrolyte solution 420, which typically enters the narrow end 413 of the cell 400 and exits the wider end 421. The reverse flow is also possible. Additional details of a continuous-feed electrochemical cell are described in U.S. Pat. No. 5,434,020 for a continuous-feed electrochemical cell with nonpacking particulate electrode, issued to John F. Cooper Jul. 18, 1995. U.S. Pat. No. 5,434,020 for a continuous-feed electrochemical cell with nonpacking particulate electrode, issued to John F. Cooper Jul. 18, 1995 is incorporated herein by this reference.

If the inclined surface of the continuous-feed electrochemical cell 400 is inclined at an angle of 5° to 20° to vertical, such that the angle of inclination is greater than the angle of repose, the active particles 402 will tend to slide over the surface (or the attached screen 404) during the process of feed, and small particles will tend to accumulate at the narrow end 413 of the cell 400. This will tend to clog the cell 400 at the bottom, where liquid flow is reduced by viscous drag. The barriers 415, 416, 417, and 418 slow movement of the active particles 402 adjacent to the 404 but will not interrupt the fall of active particles 402. The barriers 415, 416, 417, and 418 may be conductive (a part of the anode current collector) or inert. The barriers 415, 416, 417, and 418 do not completely span the bed. The barriers 415, 416, 417, and 418 increase friction for active particle 402 movement.

In one embodiment the continuous-feed electrochemical cell 400 is a zinc/ferricyanide cell. The cathode current collector 405, 406 is a porous, inert electrode supporting ferricyanide ion reduction. The electrolyte solution 420 is an electrolyte solution comprising ferrocyanide and ferricyanide.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A continuous-feed electrochemical cell apparatus, comprising:
an anode current collector;
a cathode current collector;
an electronically insulating separator between said anode current collector and said cathode current collector;
a cell cavity operatively connected to said anode current collector and said cathode current collector, wherein said cell cavity is at an angle of 5° to 20° to vertical;
electrochemically active particles within said cell cavity;
an electrolyte solution within said cell cavity; and
at least one barrier extending into said cell cavity.

2. The continuous-feed electrochemical cell apparatus of claim 1 wherein said at least one barrier is an electrically conductive barrier.

3. The continuous-feed electrochemical cell apparatus of claim 1 wherein said at least one barrier is a non-electrically conductive barrier.

4. The continuous-feed electrochemical cell apparatus of claim 1 including a screen extending along said anode current collector and wherein said at least one barrier extends perpendicular to said screen.

5. The continuous-feed electrochemical cell apparatus of claim 1 wherein said cathode current collector is an air cathode.

6. The continuous-feed electrochemical cell apparatus of claim 1 wherein said cell cavity is formed by said anode current collector; said cathode current collector, said electronically insulating separator, and a cell wall that is non-parallel to said anode current collector; said cathode current collector, and said electronically insulating separator.

7. The continuous-feed electrochemical cell apparatus of claim 1 including an electrically conductive cell wall, wherein the continuous-feed electrochemical cell apparatus produces electrical power by a voltage potential difference, wherein said cell cavity is formed by said cathode current collector and said electrically conductive cell wall, and wherein said cell wall is said anode current collector with electrical power produce by voltage potential difference between said cathode current collector and said cell wall electrically conductive.

8. The continuous-feed electrochemical cell apparatus of claim 1 including an electrically conductive cell wall, wherein the continuous-feed electrochemical cell apparatus produces electrical power by a voltage potential difference, wherein said cell cavity is formed by said cathode current collector and said cell wall, and wherein electrical power produce by voltage potential difference between said cathode current collector and said electrically conductive cell wall and by voltage potential difference between said cathode current collector and said anode current collector.

9. A continuous-feed electrochemical cell apparatus, comprising:
a cell body with a cell cavity defined by at least two cavity walls, wherein one of said cavity walls is a cavity wall that is inclined to vertical;
at least one barrier extending from said cavity wall that is inclined to vertical;
electrochemically active particles within said cell cavity;
an electrolyte solution within said cell cavity;
a cathode current collector operatively connected to said cavity wall that is inclined to vertical, to said electrochemically active particles, and to said electrolyte solution; and
an anode current collector operatively connected to said cavity wall that is inclined to vertical, to said electrochemically active particles, and to said electrolyte solution.

10. The continuous-feed electrochemical cell apparatus of claim 9 wherein said at least one barrier is an electrically conductive barrier.

11. The continuous-feed electrochemical cell apparatus of claim 9 wherein said at least one barrier is a non-electrically conductive barrier.

12. The continuous-feed electrochemical cell apparatus of claim 9 wherein said cavity wall that is inclined to vertical is inclined to vertical at an angle of 5° to 20° to vertical.

13. The continuous-feed electrochemical cell apparatus of claim 9 wherein said cavity wall that is inclined to vertical is inclined to vertical at an angle of 5° to 20° to vertical, wherein said electrochemically active particles flow along said cavity wall that is inclined to vertical is inclined to vertical at an angle of 5° to 20° to vertical, and wherein said at least one barrier is perpendicular to said cavity wall that is inclined to vertical is inclined to vertical at an angle of 5° to 20° to vertical.

14. The continuous-feed electrochemical cell apparatus of claim 9 wherein said cathode current collector is an air cathode.

15. The continuous-feed electrochemical cell apparatus of claim 9 wherein said cell cavity has an open end, wherein said electrochemically active particles enter said cell cavity and pass through said cell cavity in one direction, wherein the distance between said cavity walls promotes bridging of electrochemically active particles across said cell cavity and formation of voids between said electrochemically active particles, and wherein the ratio of said distance between said cavity walls at any point along between said cavity walls and the average diameter of aid electrochemically active particles at that point is in the range of about 1 to 7.

16. The continuous-feed electrochemical cell apparatus of claim 9 wherein said continuous-feed electrochemical cell is a zinc/ferricyanide cell, said cathode current collector is a porous, inert electrode supporting ferricyanide ion reduction, and said electrolyte solution is an electrolyte solution comprising ferrocyanide and ferricyanide.

17. A continuous-feed electrochemical cell apparatus, comprising:
a cell body with a tapered cell cavity defined by at least two nonparallel cavity walls, wherein one of said nonparallel cavity walls is a nonparallel cavity wall that is inclined to vertical at an angle of 5° to 20° to vertical;
at least one barrier connected to said nonparallel cavity wall that is inclined to vertical;
electrochemically active particles within said tapered cell cavity;
an electrolyte solution within said tapered cell cavity;
a cathode current collector operatively connected to said nonparallel cavity wall that is inclined to vertical, to said electrochemically active particles, and to said electrolyte solution;
an anode current collector operatively connected to said nonparallel cavity wall that is inclined to vertical, to said electrochemically active particles, and to said electrolyte solution; and
a porous, electronically insulating separator located between said cathode current collector and said anode current collector.

18. The continuous-feed electrochemical cell apparatus of claim 17 wherein said nonparallel cavity wall that is inclined to vertical is inclined to vertical at an angle of 5° to 20° to vertical, wherein said electrochemically active particles flow along said nonparallel cavity wall that is inclined to vertical is inclined to vertical at an angle of 5° to 20° to vertical, and wherein said at least one barrier is perpendicular to said nonparallel cavity wall that is inclined to vertical is inclined to vertical at an angle of 5° to 20° to vertical.

19. The continuous-feed electrochemical cell apparatus of claim 17 including a screen extending along said anode current collector with said at least one barrier extending perpendicular to said screen.

20. The continuous-feed electrochemical cell apparatus of claim 17 wherein said tapered cell cavity has an open end, wherein said electrochemically active particles enter said tapered cell cavity and pass through said tapered cell cavity in one direction, wherein the distance between said nonparallel cavity walls promotes bridging of electrochemically active particles across said tapered cell cavity and formation of voids between said electrochemically active particles, and wherein the ratio of said distance between said nonparallel cavity walls at any point along between said nonparallel cavity walls and the average diameter of aid electrochemically active particles at that point is in the range of about 1 to 7.
